(19) United States
(12) Patent Application Publication
(10) Pub. No.: US 2006/0061226 A1
(43) Pub. Date: Mar. 23, 2006

(54) Permanent magnet-type motor

(75) Inventors: Deok Jin Kim, Hwasung-si (KR); Young Kwan Kim, Buchun-si (KR); Jin Soo Park, Inchun-si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/202,164

(22) Filed: Aug. 12, 2005

(30) Foreign Application Priority Data
Sep. 17, 2004 (KR) 2004-74523

(51) Int. Cl. H02K 1/27

(52) U.S. Cl. 310/156.43

(57) ABSTRACT

A permanent magnet-type motor includes a stator, on which coils are wound; and a rotor located on the inside of the stator, and having a plurality of magnet pairs arranged at positions thereof corresponding to the stator, each magnet pair including a high-energy magnet having a high residual magnetic flux density or a high amount of energy and low-energy magnets having a low residual magnetic flux density or a low amount of energy, thereby limiting the increase of the material costs of the magnets, improving the torque of the motor, and increasing the capacity of the motor.

### BACKGROUND OF THE INVENTION

1. Field of the Invention

The present invention relates to a surface mounted permanent magnet-type motor, in which permanent magnets, radially arranged and magnetized, is attached to the surface of a rotor, and more particularly to a permanent magnet-type motor, which comprises magnets composed of a high-priced rare-earth element and magnets composed of low-priced ferrite to improve the capacity of the motor.

2. Description of the Related Art

Generally, permanent magnet-type motors are divided into a surface mounted permanent magnet-type motor and an interior permanent magnet-type motor according to the configurations of magnetic circuits.

FIG. 1 is a schematic plan view of an internal rotatable motor, which is one type of the conventional surface mounted permanent magnet-type motors.

The conventional surface mounted permanent magnet-type motor, in which a rotor 20 is installed on the inside of a stator 10, mainly comprises the stator 10, and the rotor 20, which is rotatably installed on the inside of the stator 10 such that the outer surface of the rotor 20 is separated from the inner surface of the stator 10 in a radial direction by a predetermined distance serving as an air gap.

The stator 10 includes a ring-shaped core 11, a plurality of teeth 13 formed on the inner circumferential surface of the ring-shaped core 11 such that the teeth 13 are separated from each other in the circumferential direction of the core 11, and coils 15 concentratedly wound on the corresponding teeth 13 and connected to an external power source.

The rotor 20 includes a ring-shaped rotor core 21 constituting a back yoke serving as a channel for magnetic flux, and magnets 25, N and S poles of which are alternately arranged on the outer circumferential surface of the rotor core 21 in a radial direction and connected to each other to have a ring-shaped magnet assembly so that the magnet assembly is rotated by the electromagnetic interaction of the magnets 25 when a current flows along the coils 15.

The stator 10 has twenty four slots, each of which includes the coil 15 wound on the corresponding one of the teeth 13, and the rotor 20 has sixteen poles, each of which includes the magnet 25 composed of ferrite or ceramic of a uniform thickness attached to the surface of the rotor core 21.

In order to improve the torque of the surface mounted permanent magnet-type motor, there is a method for improving the stacked length of the rotor 20 or a method for using the magnets 25 composed of a high-priced rare-earth element.

In case that the stacked length of the rotor of the permanent magnet-type motor is increased by the use of magnets composed of ferrite, since the motor has an increased volume, it is difficult to apply the motor to space-limited products, such as drum-type washing machine. Further, since the residual magnetic flux density of the ferrite magnet is low, the increase of the torque of the motor is relatively low compared to the increase in the volume of the motor.

Further, in case that all of the magnets 25 of the permanent magnet-type motor are composed of a rare-earth element, the torque of the motor is significantly increased while the material costs of the motor are excessively increased.

### SUMMARY OF THE INVENTION

Therefore, the present invention has been made in view of the above problems, and it is an object of the present invention to provide a permanent magnet-type motor, which comprises magnets composed of a high-priced and high-energy rare-earth element and magnets composed of low-priced and low-energy ferrite to improve the torque of the motor, thereby improving the capacity of the motor.

In accordance with one aspect of the present invention, the above and other objects can be accomplished by the provision of a permanent magnet-type motor comprising: a stator, on which coils are wound; and a rotor having magnets arranged at positions thereof corresponding to the stator and composed of different materials having different residual magnetic flux densities or different amounts of energy.

Preferably, the motor may be an internal rotatable motor in which the rotor is located in the stator.

Further, preferably, the magnets composed of different materials may be arranged in an area for forming one magnetic pole.

Moreover, preferably, one high-energy magnet having a high residual magnetic flux density and a high amount of energy may be arranged at the central portion of the magnetic pole, and two low-energy magnets having a low residual magnetic flux density and a low amount of energy may be respectively arranged at both ends of the high-energy magnet.

More preferably, the high-energy magnet may have a thickness equal to or less than those of the low-energy magnets.

Preferably, the high-energy magnet may be a rare-earth magnet, and the low-energy magnets may be ferrite magnets or ceramic magnets.

Further, preferably, the low-energy magnets may be obtained by forming N or S pole on a single magnet piece.

Moreover, preferably, a part of the rotor for constituting a back yoke may be produced by spiral winding.

In accordance with another aspect of the present invention, there is provided a permanent magnet-type motor comprising: a stator, on which coils are wound; and a rotor located on the inside of the stator, and having a plurality of magnet pairs arranged at positions thereof corresponding to the stator, each magnet pair including a high-energy magnet having a high residual magnetic flux density and a high amount of energy and low-energy magnets having a low residual magnetic flux density and a low amount of energy.

The permanent magnet-type motor of the present invention comprises magnets, having a low thickness, composed of a high-priced and high-energy rare-earth element, and magnets composed of low-priced and low-energy ferrite, thereby limiting the increase the material costs of the magnets, improving the torque of the motor, and increasing the capacity of the motor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a plan view of a conventional permanent magnet-type motor;

FIG. 2 is a plan view of a permanent magnet-type motor in accordance with the present invention;

FIGS. 3A and 3B are schematic views respectively illustrating the magnetic flux distributions of the conventional permanent magnet-type motor and the permanent magnet-type motor of the present invention;

FIG. 4 is a graph comparatively illustrating the pore magnetic flux densities of the conventional permanent magnet-type motor and the permanent magnet-type motor of the present invention; and

FIG. 5 is a graph comparatively illustrating the back electromotive forces of the conventional permanent magnet-type motor and the permanent magnet-type motor of the present invention.

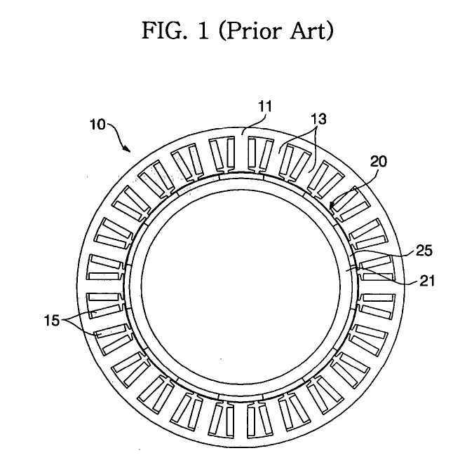

### DESCRIPTION OF THE PREFERRED EMBODIMENTS

Now, an embodiment of a permanent magnet-type motor in accordance with the present invention will be described in detail with reference to the annexed drawings.

Although the permanent magnet-type motor of the present invention may have a plurality of embodiments, hereinafter, the most preferred embodiment of the permanent magnet-type motor will be described. The essential structure of the permanent magnet-type motor of the present invention is identical to that of the preceding conventional permanent magnet-type motor, and the detailed description thereof will be thus omitted.

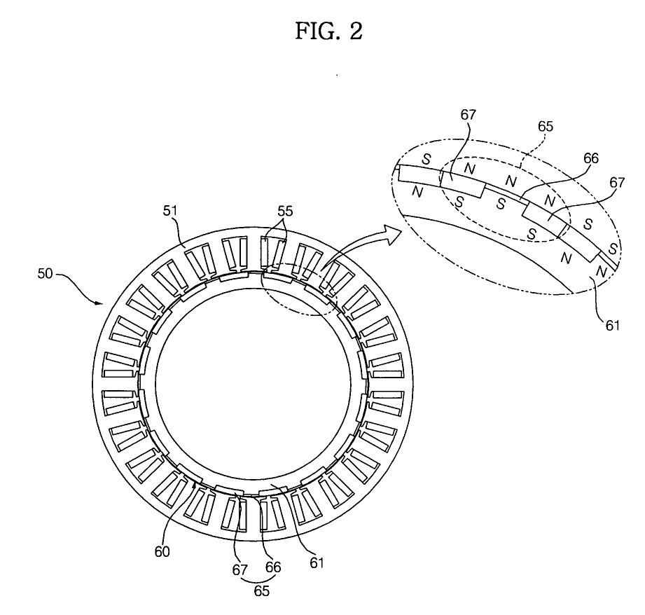

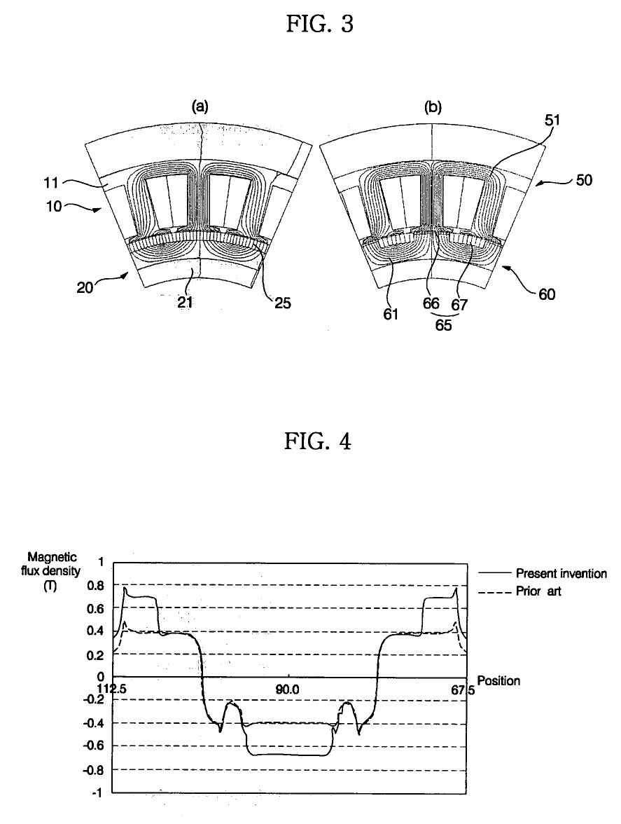

As shown in FIG. 2, the permanent magnet-type motor of the present invention is a surface mounted-type internal rotatable motor, and comprises a stator 50, on which coils 55 are wound, and a rotor 60 having a plurality of magnet pairs 65, which are arranged at positions corresponding to the stator 50 and composed of materials having different residual magnetic flux densities or different amounts of energy.

Here, the motor is an internal rotatable motor, in which the rotor 60 is located in the stator 50. The stator 50 includes a ring-shaped core 51, and the coils 55 concentratedly wound on each of the teeth, which are formed on the inner circumferential surface of the ring-shaped core 51 and separated from each other in the circumferential direction of the core 51, and connected to an external power source.

The rotor 60 includes a ring-shaped rotor core 61 constituting a back yoke serving as a channel for magnetic flux, and the magnet pairs 65 composed of different materials, N and S poles of which are alternately arranged on the outer circumferential surface of the rotor core 61 in a radial direction and connected to have a ring-shaped magnet assembly so that the magnet assembly is rotated by the electromagnetic interaction of the magnet pairs 65 when a current flows along the coils 55.

Here, preferably, the stator 50 has the same structure and number of slots as those of the stator of the conventional permanent magnet-type motor, and the rotor 60 has sixteen poles, thereby forming a twenty four (24) slots/sixteen (16) poles combination.

Particularly, magnets of each of the magnet pairs 65, which are composed of different materials, are arranged in an area for forming one magnetic pole. One high-energy magnet 66 having a high residual magnetic flux density and a high amount of energy is arranged at the central portion of the magnetic pole, and two low-energy magnets 67 having a low residual magnetic flux density and a low amount of energy are arranged at both ends of the high-energy magnet 66.

The high-energy magnet 66 has a high coercive force for demagnetization. Accordingly, preferably, the high-energy magnet 66 has a thickness equal to or less than those of the low-energy magnets 67. The low-energy magnets 67 are obtained by forming N or S pole on a single magnet piece.

The high-energy magnet 66 is a rare-earth magnet, and the low-energy magnet 67 is a ferrite magnet or a ceramic magnet. The rare-earth magnet is a magnet composed of a rare-earth element, and has a coercive force ten times that of the general magnets.

Preferably, the rotor core 61 of the rotor 60 for constituting a back yoke is produced by spiral winding.

Hereinafter, the function of the above-described permanent magnet-type motor of the present invention will be described in detail.

As shown in FIG. 2, the high-energy magnet 66 composed of a rare-earth element and the low-energy magnets 67 composed of ferrite are combined to form an area constituting one N or S pole. Accordingly, the displacement of the high-energy magnet 66, composed of a rare-earth element having a low thickness, between the low-energy magnets 67, composed of ferrite, facilitates the increase in the torque of the motor and limits the increase of material costs of the motor.

FIG. 4 is a graph comparatively illustrating the pore magnetic flux densities of the conventional permanent magnet-type motor and the permanent magnet-type motor of the present invention. As shown in FIG. 4, it is proved that the permanent magnet-type motor of the present invention has an increased pore magnetic flux density compared to the conventional permanent magnet-type motor.

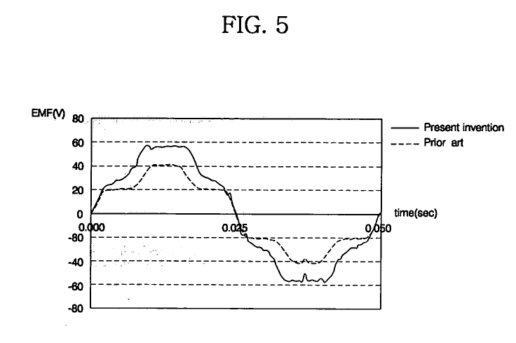

FIG. 5 is a graph comparatively illustrating the back electromotive forces of the conventional permanent magnet-type motor and the permanent magnet-type motor of the present invention. As shown in FIG. 5, since the back electromotive force of the conventional permanent magnet-type motor is 28 Vrms, and the back electromotive force of the permanent magnet-type motor of the present invention is 41 Vrms, it is proved that the permanent magnet-type motor of the present invention has increased back electromotive force and increased torque compared to the conventional permanent magnet-type motor having the same stack structure and volume.

As apparent from the above description, the present invention provides a permanent magnet-type motor, which comprises magnets, having a low thickness, composed of a high-priced and high-energy rare-earth element and magnets composed of low-priced and low-energy ferrite, thereby limiting the increase of the material costs of the magnets, improving the torque of the motor, and increasing the capacity of the motor.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

The present disclosure relates to subject matter contained in Korean Application No. 10-2004-0074523, filed on Sep. 17, 2004, the contents of which are herein expressly incorporated by reference in its entirety.

What is claimed is:

1. A permanent magnet-type motor comprising:
a stator, on which coils are wound; and
a rotor having magnets arranged at positions thereof corresponding to the stator and composed of different materials having different residual magnetic flux densities or different amounts of energy.

2. The permanent magnet-type motor as set forth in claim 1,
wherein the motor is an internal rotatable motor in which the rotor is located in the stator.

3. The permanent magnet-type motor as set forth in claim 1,
wherein the magnets composed of different materials are arranged in an area for forming one magnetic pole.

4. The permanent magnet-type motor as set forth in claim 3,
wherein one high-energy magnet having a high residual magnetic flux density and a high amount of energy is arranged at the central portion of the magnetic pole, and two low-energy magnets having a low residual magnetic flux density and a low amount of energy are respectively arranged at both ends of the high-energy magnet.

5. The permanent magnet-type motor as set forth in claim 4,
wherein the high-energy magnet has a thickness equal to or less than those of the low-energy magnets.

6. The permanent magnet-type motor as set forth in claim 5,
wherein the high-energy magnet is a rare-earth magnet.

7. The permanent magnet-type motor as set forth in claim 5,
wherein the low-energy magnets are ferrite magnets or ceramic magnets.

8. The permanent magnet-type motor as set forth in claim 4,
wherein the low-energy magnets are obtained by forming N or S pole on a single magnet piece.

9. The permanent magnet-type motor as set forth in claim 1,
wherein a part of the rotor for constituting a back yoke is produced by spiral winding.

10. A permanent magnet-type motor comprising:
a stator, on which coils are wound; and
a rotor located on the inside of the stator, and having a plurality of magnet pairs arranged at positions thereof corresponding to the stator, each magnet pair including a high-energy magnet having a high residual magnetic flux density and a high amount of energy and low-energy magnets having a low residual magnetic flux density and a low amount of energy.

11. The permanent magnet-type motor as set forth in claim 10,
wherein each magnet pair is arranged in an area for forming one magnetic pole.

12. The permanent magnet-type motor as set forth in claim 11,
wherein the high-energy magnet is arranged at the central portion of the magnetic pole, and the low-energy magnets are respectively arranged at both ends of the high-energy magnet.

13. The permanent magnet-type motor as set forth in claim 10,
wherein the high-energy magnet has a thickness equal to or less than those of the low-energy magnets.

14. The permanent magnet-type motor as set forth in claim 10,
wherein the high-energy magnet is a rare-earth magnet.

15. The permanent magnet-type motor as set forth in claim 10,
wherein the low-energy magnets are ferrite magnets or ceramic magnets.

16. The permanent magnet-type motor as set forth in claim 10,
wherein the low-energy magnets are obtained by forming N or S pole on a single magnet piece.

17. A permanent magnet-type motor comprising:
a stator, on which coils are wound; and
a rotor located on the inside of the stator, and having magnets arranged at positions thereof corresponding to the stator,
wherein the rotor includes magnet pairs continuously arranged, each magnet pair including a high-energy magnet having a high residual magnetic flux density or a high amount of energy and low-energy magnets having a low residual magnetic flux density or a low amount of energy arranged at both ends of the high-energy magnet.

18. The permanent magnet-type motor as set forth in claim 17,
wherein each magnet pair is arranged in an area for forming one magnetic pole.

19. The permanent magnet-type motor as set forth in claim 17,
wherein the high-energy magnet has a thickness equal to or less than those of the low-energy magnets.

20. The permanent magnet-type motor as set forth in claim 17,
wherein a part of the rotor for constituting a back yoke is produced by spiral winding.
